(19) United States
(12) Patent Application Publication
(10) Pub. No.: US 2024/0141902 A1
(43) Pub. Date: May 2, 2024

(54) ELECTRIC WATER PUMP

(71) Applicant: COAVIS, Sejong-si (KR)

(72) Inventors: Hyun Tae LEE, Sejong-si (KR); Woo Keun LEE, Sejong-si (KR)

(21) Appl. No.: 18/498,165

(22) Filed: Oct. 31, 2023

(30) Foreign Application Priority Data
Nov. 1, 2022 (KR) 10-2022-0143712

(51) Int. Cl. F04D 13/06; F04D 1/00

(52) U.S. Cl. CPC F04D 13/0606; F04D 1/00

(57) ABSTRACT

Provided is an electric water pump which may have a reduced overall size by simplifying a power transfer structure between a power unit and a rotation unit, and effectively cool a stator and a rotor without any additional structure for their cooling by distributing a fluid between the power unit and the rotation unit.

### CROSS-REFERENCE TO RELATED APPLICATIONS

This application claims priority under 35 U.S.C. § 119 to Korean Patent Application No. 10-2022-0143712, filed on Nov. 1, 2022, in the Korean Intellectual Property Office, the disclosure of which is incorporated herein by reference in its entirety.

### TECHNICAL FIELD

The following disclosure relates to an electric water pump, and more particularly, to an electric water pump which may have a simplified structure for generating a rotational force in the water pump and effectively cool its related components.

### BACKGROUND

Mobility may include a water pump cooling each part by circulating a cooling medium to a part that needs to be cooled.

The water pump applied to a conventional vehicle may be always operated to circulate coolant regardless of a temperature condition of an engine when the engine is operated. Accordingly, a discharge flow rate of the water pump may be linearly increased in proportion to revolutions per minute (RPM) of the engine, and the engine may be supercooled during its warm-up stage to have a delayed warm-up speed.

That is, the discharge flow rate of the water pump may be set to the maximum output (or a high speed/high load) condition to prevent engine overheating and protect a cooling system component. Therefore, the discharge flow rate may be linearly increased even under a low load condition for the engine to have a delayed temperature increase time in the warm-up stage, thus causing its unnecessary cooling.

Accordingly, an electric water pump which is operated by an operation of a motor may be applied to the vehicle. The motor may be positioned in the electric water pump, thus increasing a size of the pump and requiring additional cooling of the motor. However, conventionally, there is a lack of measures to cool the inside of the motor of the electric water pump, and there is a need for an additional cooling path to distribute a separate cooling medium. As a result, the pump may have a more complex internal structure and an increased volume.

The contents described as the related art are provided only to assist in understanding the background of the present disclosure and should not be considered as corresponding to the related art known to those skilled in the art.

### RELATED ART DOCUMENT

[Patent Document]

(Patent Document 1) KR 10-1305671 B1 (Sep. 2, 2013.09.02)

### SUMMARY

An embodiment of the present disclosure is directed to providing an electric water pump which may have a simplified structure for generating a rotational force in the water pump and effectively cool its related components.

In one general aspect, an electric water pump includes: a motor housing including an inlet through which a fluid is introduced, and having an internal space; a cover coupled to the motor housing, including an outlet through which the fluid is discharged, and having a distribution space communicating with the internal space of the motor housing; a power unit positioned in the internal space of the motor housing; and a rotation unit positioned to be rotatable by the power unit in the internal space of the motor housing, including an impeller positioned in the distribution space of the cover, allowing the fluid introduced through the inlet to pass therein for the fluid to be distributed from the inlet to the outlet as the impeller is rotated during its rotation, and being disposed to be spaced apart from the power unit to form a flow path, thereby distributing the fluid through the flow path.

A support bracket on which a shaft may be rotatably mounted is positioned in an internal space of the motor housing, and the impeller is coupled to the shaft.

The cover may include a bushing part on which the shaft is rotatably seated.

The impeller may include a rotating plate and a plurality of blades, and the shaft may pass through and be coupled to a rotation center of the rotating plate.

The blade may curvedly extend from the rotating plate, extend from an outer end of the rotating plate toward the center of the rotating plate, and extend to a position spaced apart from the center of the rotating plate.

The support bracket may have a through hole positioned around the shaft to distribute the fluid introduced through the inlet into the rotation unit, and the through hole may have a support rib extending across the through hole.

The power unit may include a stator and a molding part surrounding and sealing the stator, and the molding part may be fixed to the internal space of the housing.

The rotation unit may include a rotor part including a built-in magnet, and the impeller coupled to the rotor part and rotated together with the rotor part.

The rotor part may include a rotating end having a cylindrical shape and including the built-in magnet to allow the fluid to be distributed therein, and a coupling end extending radially from the bottom of the rotating end and coupled with the impeller.

The flow path may be formed between the molding part of the power unit and the rotor part of the rotation unit to allow the fluid to be distributed, and the internal space of the motor housing and the distribution space of the cover may communicate with each other by the flow path.

### BRIEF DESCRIPTION OF THE DRAWINGS

FIG. 1 is a view showing an electric water pump according to an embodiment of the present disclosure.

FIG. 2 is a side cross-sectional view of the electric water pump shown in FIG. 1.

FIG. 3 is a top side view of the electric water pump shown in FIG. 1.

FIG. 4 is a view of an internal configuration of the electric water pump shown in FIG. 1.

FIG. 5 is a view showing a rotation unit of the electric water pump shown in FIG. 1.

### DETAILED DESCRIPTION OF EMBODIMENTS

Hereinafter, an embodiment of the present disclosure is described in detail with reference to the accompanying drawings. The same or similar components are denoted by the same reference numerals independent of the drawing numerals, and an overlapping description for the same or similar components is omitted.

In addition, the terms “module” and “unit” for components used in the following description are used only to easily describe the present disclosure. Therefore, these terms do not have meanings or roles that distinguish themselves from each other.

Further, in describing the embodiment of the present disclosure, in a case where it is decided that a detailed description for the known art related to the present disclosure may obscure the gist, the detailed description is omitted. Furthermore, it is to be understood that the accompanying drawings are provided only to allow the embodiment of the present disclosure to be easily understood, and the spirit of the present disclosure is not limited by the accompanying drawings and includes all the modifications, equivalents and substitutions included in the spirit and scope of the present disclosure.

Terms including ordinal numbers such as “first”, “second”, and the like, may be used to describe various components. However, these components are not limited by these terms. The terms are used only to distinguish one component from another component.

It is to be understood that if one component is referred to as being “connected to” or “coupled to” another component, one component may be directly connected to or directly coupled to another component, or may be connected to or coupled to another component while having a third component interposed therebetween. On the other hand, it is to be understood that when one component is referred to as being “directly connected to” or “directly coupled to” another component, it may be connected or coupled to another component without a third component interposed therebetween.

A term of a singular number may include its plural number unless explicitly indicated otherwise in the context.

It should be understood that the terms “include” and “have” used in the specification specify the presence of features, numerals, steps, operations, components, parts, or combinations thereof, mentioned in the specification, and do not preclude the presence or addition of one or more other features, numerals, steps, operations, components, parts, or combinations thereof.

Hereinafter, an electric water pump according to an embodiment of the present disclosure is described with reference to the accompanying drawings.

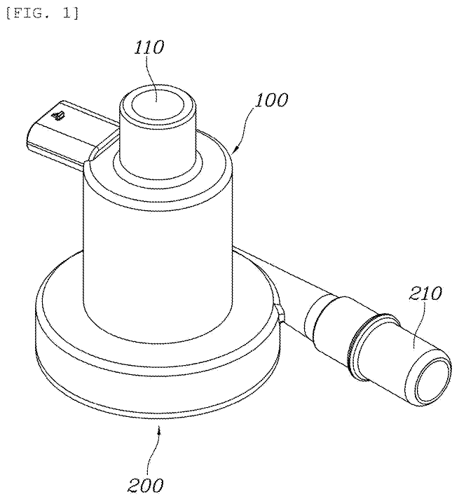

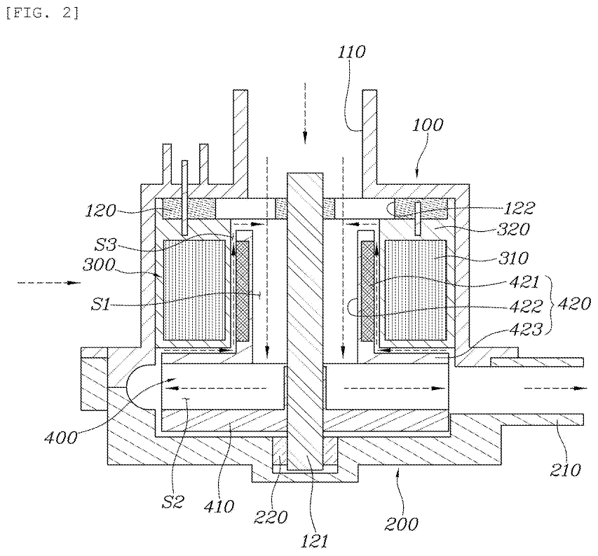

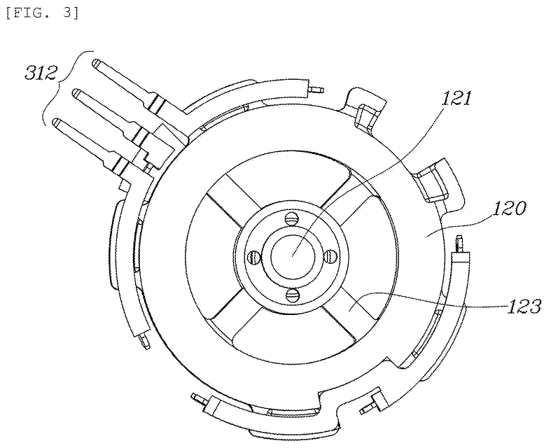

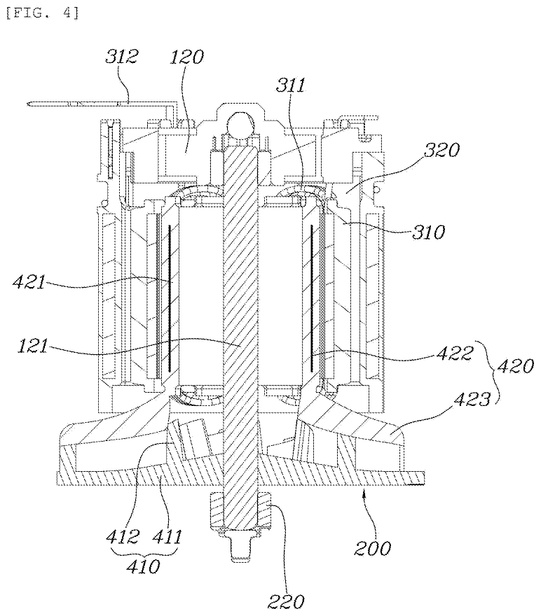

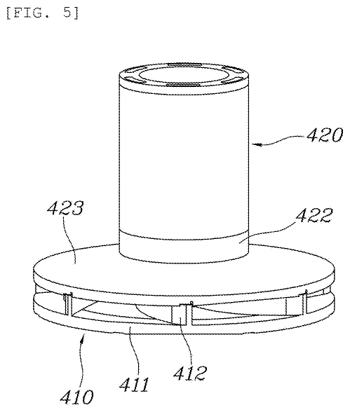

FIG. 1 is a view showing an electric water pump according to an embodiment of the present disclosure; FIG. 2 is a side cross-sectional view of the electric water pump shown in FIG. 1; FIG. 3 is a top side view of the electric water pump shown in FIG. 1; FIG. 4 is a view of an internal configuration of the electric water pump shown in FIG. 1; and FIG. 5 is a view showing a rotation unit of the electric water pump shown in FIG. 1.

As shown in FIGS. 1 to 4, the electric water pump according to the present disclosure includes: a motor housing 100 including an inlet 110 through which a fluid is introduced, and having an internal space S1; a cover 200 coupled to the motor housing 100, including an outlet 210 through which the fluid is discharged, and having a distribution space S2 communicating with the internal space S1 of the motor housing 100; a power unit 300 positioned in the internal space S1 of the motor housing 100; and a rotation unit 400 positioned to be rotatable by the power unit 300 in the internal space S1 of the motor housing 100, including an impeller 410 positioned in the distribution space S2 of the cover 200, allowing the fluid introduced through the inlet 110 to pass therein for the fluid to be distributed from the inlet 110 to the outlet 210 as the impeller 410 is rotated during its rotation, and being disposed to be spaced apart from the power unit 300 to form a flow path S3, thereby distributing the fluid through the flow path S3.

The motor housing 100 and the cover 200 may be manufactured separately from each other and fused together, and when these components are coupled to each other, the internal space S1 of the motor housing 100 and the distribution space S2 of the cover 200 may communicate with each other. Accordingly, the fluid introduced through the inlet 110 of the motor housing 100 may pass through the internal space S1 and the distribution space S2, and be discharged to the outlet 210 of the cover 200.

In the present disclosure, the fluid may be coolant.

The power unit 300 and the rotation unit 400 may be positioned in the internal space S1 of the motor housing 100, and the rotation unit 400 may include the impeller 410. Accordingly, when the impeller 410 is rotated by the power unit 300, the fluid introduced through the inlet 110 may pass through the internal space S1 to be moved to the distribution space S2, and then be compressed by the impeller 410 to be discharged to the outlet 210.

Here, the outlet 210 may be positioned on the side of the cover 200, and the fluid introduced into the distribution space S2 may be discharged to the outlet 210 as a discharge pressure is increased by the rotation of the impeller 410.

In the present disclosure, the rotation unit 400 may be positioned in the internal space S1 of the motor housing 100, and positioned to be rotatable inside the power unit 300. That is, the power unit 300 may include a stator 310, and the rotation unit 400 may include a rotor to rotate the impeller 410 positioned in the rotation unit 400.

In addition, the rotation unit 400 may allow the fluid to pass therein and then to be discharged to the outlet 210 by the rotation of the impeller 410 as the fluid introduced through the inlet 110 of the motor housing 100 passes through the inside of the rotation unit 400 and is moved to the distribution space S2 of the cover 200 when the impeller 410 is rotated.

In particular, the rotation unit 400 may be disposed to be spaced apart from the power unit 300 inside the power unit 300, thus forming the flow path S3 as the rotation unit 400 and the power unit 300 are spaced apart from each other. In this way, the flow path S3 may be formed between the rotation unit 400 and the power unit 300. Accordingly, the fluid may be moved through the flow path S3, and the power unit 300 and the rotation unit 400 may be cooled as some of the fluid passes through the flow path S3.

In addition, the rotation unit 400 may be disposed to be spaced apart from the power unit 300, thus avoiding friction due to their mutual contact, and a friction reduction effect may be generated due to a water film as the fluid is moved through the flow path S3 between the rotation unit 400 and the power unit 300.

As described above, the pump of the present disclosure may have a simplified structure by configuring the power unit 300 including the stator 310, the rotation unit 400 including the rotor, and the impeller 410 integrated into the rotation unit 400, and may efficiently cool its parts without a separate cooling structure as the fluid moved through the flow path S3 between the power unit 300 and the rotation unit 400 cools the power unit 300 and the rotation unit 400.

To specifically describe the present disclosure described in detail above, a support bracket 120 on which a shaft 121 is rotatably mounted may be positioned in the internal space S1 of the motor housing 100, and the impeller 410 may be coupled to the shaft 121.

That is, the support bracket 120 may be fixed to a side of the inlet 110, which is opposite to the cover 200, in the internal space S1 of the motor housing 100. In addition, the shaft 121 coupled to the impeller 410 may be rotatably mounted on the support bracket 120, and the impeller 410 may thus be rotatably supported by the support bracket 120 through the shaft 121, thereby stabilizing the rotational operation of the impeller 410. Accordingly, the support bracket 120 may have a bearing at its portion on which the shaft 121 is mounted.

The support bracket 120 may have a through hole 122 positioned around the shaft 121 to distribute the fluid introduced through the inlet 110 into the rotation unit 400, and the through hole 122 may have a support rib 123 extending across the through hole 122.

The through hole 122 of the support bracket 120 may have a diameter larger than a diameter of a space where the fluid is distributed between the rotation unit 400 and the power unit 300, which is larger than an inner diameter of a rotating end 422 included in a rotor part 420 of the rotation unit 400, which are described below. Accordingly, the fluid introduced through the inlet 110 may smoothly pass through the through hole 122 of the support bracket 120, and be distributed to the internal space S1 of the motor housing 100 and the distribution space S2 of the cover 200.

In addition, the support rib 123 extending across the through hole 122 may be formed in the support bracket 120, thereby forming a structure in which a part of the support bracket 120 coupled to the motor housing 100 and its part on which the shaft 121 is mounted are connected with each other. In addition, even though the support bracket 120 has the through hole 122, the support bracket 120 may ensure its own rigidity through the connection structure of the support rib 123.

Meanwhile, as shown in FIG. 2, the cover 200 may include a bushing part 220 on which the shaft 121 is rotatably seated.

A portion of the cover 200 may be recessed for an end of the shaft 121 to be inserted thereto, the bushing part 220 may be positioned in the recessed portion, and the end of the shaft 121 may be rotatably seated on the bushing part 220. The bushing part 220 may have a bearing structure, and the end of shaft 121 may be seated and supported in a rotatable state, thus preventing bending deformation of the shaft 121 and maintaining its strong mounting state. In addition, the bushing part 220 may have improved cooling performance by ensuring lubrication of its operating surface through the bearing structure.

Meanwhile, as shown in FIGS. 2 and 4, the impeller 410 may include a rotating plate 411 and a plurality of blades 412, and the shaft 121 may pass through and be coupled to a rotation center of the rotating plate 411.

In this way, the impeller 410 may have the plurality of blades 412 disposed on the one rotating plate 411 while being spaced apart at regular intervals from each other. Here, the rotating plate 411 may be smaller than the distribution space S2 of the cover 200, the plurality of blades 412 may be disposed on a cross section of the rotating plate 411 while being spaced apart at the regular intervals from each other, and the fluid may thus be transferred as the blades 412 are rotated together when the rotating plate 411 is rotated.

Here, the blade 412 may curvedly extend from the rotating plate 411, extend from an outer end of the rotating plate 411 toward the center of the rotating plate 411, and extend from the rotation center to which the shaft 121 is connected to its position spaced apart from the shaft 121. That is, in the present disclosure, the fluid introduced through the inlet 110 may be moved into the rotation unit 400. Therefore, the blade 412 may be positioned to be spaced apart from the rotation center of the rotating plate 411 to allow the fluid passing through the inside of the rotation unit 400 to be smoothly moved between the blades 412.

Meanwhile, as shown in FIG. 2, the power unit 300 may include the stator 310 and a molding part 320 surrounding and sealing the stator 310, and the molding part 320 may be fixed to the internal space S1 of the housing.

That is, the power unit 300 may include the stator 310 and the molding part 320, and the stator 310 may include a plurality of coils 311 and a terminal 312 electrically connecting the respective coils 311 to each other. In particular, in the present disclosure, the power unit 300 may be exposed to the fluid as the power unit 300 is positioned in the internal space S1 of the motor housing 100. However, the stator 310 may cause electrical damage when exposed to the fluid. Accordingly, the stator 310 may be surrounded and sealed by the molding part 320 to prevent the electrical damage caused by the fluid, and may be insulated by the molding part 320 made of rubber or plastic.

In addition, a position of the stator 310 may also be fixed as the molding part 320 is coupled and fixed to the internal space S1 of the motor housing 100. That is, an overall size of the pump may be reduced as the stator 310 is mounted on the motor housing 100 through the molding part 320 without a separate fixing structure for fixing the stator 310, and the fluid may flow into the corresponding space as the structure for fixing the stator 310 is removed.

Meanwhile, as shown in FIGS. 2 and 4, the rotation unit 400 may include the rotor part 420 including a built-in magnet 421 and the impeller 410 coupled to the rotor part 420 and rotated together with the rotor part 420.

The rotation unit 400 may include the rotor part 420 and the impeller 410, and the rotor part 420 and the impeller 410 may be integrated with each other and rotated together.

In particular, the rotor part 420 may include the built-in magnet 421 and be rotated by magnetism of the power unit 300 including the stator 310, and when the rotor part 420 is rotated, the impeller 410 may be rotated together to transfer the fluid.

In this way, the rotation unit 400 may include the rotor part 420 and the impeller 410 integrated with each other, thus requiring no separate means to connect the conventional rotor with the impeller to simplify the entire structure of the pump, and the rotor part 420 and the impeller 410 may be directly connected with each other to ensure no power loss.

In detail, as shown in FIG. 5, the rotor part 420 may include the rotating end 422 having a cylindrical shape and including the built-in magnet 421 to allow the fluid to be distributed therein, and a coupling end 423 extending radially from the bottom of the rotating end 422 and coupled with the impeller 410.

As described above, the rotor part 420 may include the rotating end 422 and the coupling end 423, the rotating end 422 may include the built-in magnet 421 to be rotated by the magnetism generated from the stator 310 of the power unit 300, and the impeller 410 may be firmly coupled to the coupling end 423 as the coupling end 423 extends radially from the rotating end 422.

In particular, the rotating end 422 may have a hollow cylindrical shape, thus distributing the fluid into its inner hollow. Accordingly, the fluid introduced through the inlet 110 of the motor housing 100 may pass through the inside of the rotating end 422 of the rotor part 420 to be moved to the impeller 410, and the discharge pressure may be increased by the rotation of the impeller 410 to thus discharge the fluid through the outlet 210 of the cover 200.

In addition, the rotating end 422 may include the built-in magnet 421 along its circumference, thus performing a high-speed rotational operation by the magnetism generated from the stator 310.

The radially extending coupling end 423 may be formed at the bottom of the rotating end 422, and the impeller 410 may thus be coupled to the coupling end 423. That is, the impeller 410 may include the plurality of blades 412, and the plurality of blades 412 may be disposed to be spaced apart from each other along the circumference of the coupling end 423 and coupled with each other. In addition, the rotor part 420 may include the radially-spreading coupling end 423 to secure its part to which the impeller 410 is coupled, thereby maintaining its strong coupling with the impeller 410.

Meanwhile, the flow path S3 may be formed between the molding part 320 of the power unit 300 and the rotor part 420 of the rotation unit 400 to allow the fluid to be distributed, and the internal space S1 of the motor housing 100 and the distribution space S2 of the cover 200 may communicate with each other by the flow path S3.

As shown in FIG. 2, the molding part 320 and the rotor part 420 may be disposed to be spaced apart from each other, thus forming the flow path S3 through which the fluid is distributed in a space between these two parts spaced apart from each other.

In this way, the flow path S3 through which fluid may be distributed may be formed between the molding part 320 and the rotor part 420, thus allowing the fluid distributed through the flow path S3 to cool the power unit 300 and the rotation unit 400.

Accordingly, the fluid may be introduced through the inlet 110 of the motor housing 100, pass through the inside of the rotation unit 400, and then be moved to the impeller 410. The fluid may then be discharged from the distribution space S2 of the cover 200 through the outlet 210 by the rotation of the impeller 410. Some of the fluids may be introduced and moved to the flow path S3 to perform cooling by exchanging heat with the power unit 300 and the rotation unit 400, then be moved into the rotation unit 400, and re-circulated.

As a result, the water film may be formed in the fluid distributed through the flow path S3 between the rotation unit 400 and the power unit 300 to reduce the friction when the rotation unit 400 is rotated, thereby performing a smooth rotational operation.

In addition, the fluid may be distributed between the power unit 300 and the rotation unit 400, and the power unit 300 and the rotation unit 400 may thus be cooled by the fluid, making it easy to manage the temperature of the power unit 300 and the rotation unit 400, and making it possible to cool the power unit 300 and the rotation unit 400 without any separate cooling structure.

The electric water pump having the structure described above may have a reduced overall size by simplifying a power transfer structure between the power unit and the rotation unit, and effectively cool the stator and the rotor without any additional structure for the cooling by distributing the fluid between the power unit and the rotation unit.

As set forth above, the electric water pump having the structure described above may have the reduced overall size by simplifying the power transfer structure between the power unit and the rotation unit, and effectively cool the stator and the rotor without any additional structure for their cooling by distributing the fluid between the power unit and the rotation unit.

Although the present disclosure is shown and described with respect to the specific embodiment, it is apparent to those skilled in the art that the present disclosure may be variously modified and altered without departing from the spirit and scope of the present disclosure as defined by the following claims.

1. An electric water pump comprising:
a motor housing including an inlet through which a fluid is introduced, and having an internal space;
a cover coupled to the motor housing, including an outlet through which the fluid is discharged, and having a distribution space communicating with the internal space of the motor housing;
a power unit positioned in the internal space of the motor housing; and
a rotation unit positioned to be rotatable by the power unit in the internal space of the motor housing, including an impeller positioned in the distribution space of the cover, allowing the fluid introduced through the inlet to pass therein for the fluid to be distributed from the inlet to the outlet as the impeller is rotated during its rotation, and being disposed to be spaced apart from the power unit to form a flow path, thereby distributing the fluid through the flow path.

2. The pump of claim 1, wherein a support bracket on which a shaft is rotatably mounted is positioned in an internal space of the motor housing, and the impeller is coupled to the shaft.

3. The pump of claim 2, wherein the cover includes a bushing part on which the shaft is rotatably seated.

4. The pump of claim 2, wherein the impeller includes a rotating plate and a plurality of blades, and the shaft passes through and is coupled to a rotation center of the rotating plate.

5. The pump of claim 4, wherein the each of the blades curvedly extends from the rotating plate, extends from an outer end of the rotating plate toward the rotation center of the rotating plate, and extends to a position spaced apart from the rotation center of the rotating plate.

6. The pump of claim 2, wherein the support bracket has a through hole positioned around the shaft to distribute the fluid introduced through the inlet into the rotation unit, and the through hole has a support rib extending across the through hole.

7. The pump of claim 1, wherein the power unit includes a stator and a molding part surrounding and sealing the stator, and the molding part is fixed to the internal space of the housing.

8. The pump of claim 7, wherein the rotation unit includes a rotor part including a built-in magnet, and the impeller coupled to the rotor part and rotated together with the rotor part.

9. The pump of claim 8, wherein the rotor part includes a rotating end having a cylindrical shape and including the built-in magnet to allow the fluid to be distributed therein, and a coupling end extending radially from a bottom of the rotating end and coupled with the impeller.

10. The pump of claim 8, wherein the flow path is formed between the molding part of the power unit and the rotor part of the rotation unit to allow the fluid to be distributed, and the internal space of the motor housing and the distribution space of the cover communicate with each other by the flow path.
